(19) United States
(12) Patent Application Publication
(10) Pub. No.: US 2024/0213613 A1
(43) Pub. Date: Jun. 27, 2024

(54) CELL CARRIER STRUT, CELL CARRIER COMPOSITE SYSTEM AS WELL AS BATTERY CARRIER AND BATTERY HOUSING

(71) Applicant: POLYTEC PLASTICS Germany GmbH & Co. KG, Lohne (DE)

(72) Inventors: Tobias BURKERT, Osnabrück (DE); Jorge SOARES, Wettringen (DE); Christoph LESON, Dinklage (DE)

(21) Appl. No.: 18/545,277

(22) Filed: Dec. 19, 2023

(30) Foreign Application Priority Data
Dec. 23, 2022 (DE) 10 2022 134 726.5

(51) Int. Cl. H01M 50/291; H01M 50/209; H01M 50/213; H01M 50/242; H01M 50/264; H01M 50/293

(52) U.S. Cl. CPC H01M 50/291; H01M 50/209; H01M 50/213; H01M 50/242; H01M 50/264; H01M 50/293

(57) ABSTRACT

A cell carrier strut for receiving and separating several battery cells comprising a carrier body extending along an extension direction from a first end to a second end and a stacking direction orthogonal to the extension direction, wherein the carrier body comprises a separating web for forming a separating section in the stacking direction, the separating web having a first and a second side surface opposite one another, and wherein the first and/or the second side surface comprises, along the extension direction, several elevations adapted to the battery cells to be received for receiving the battery cells.

### CROSS REFERENCE TO RELATED APPLICATIONS

This application claims priority to German Patent Application No. DE 10-2022-134-726.5, filed Dec. 12, 2022, incorporated herein by reference.

The present invention relates to a cell carrier strut for receiving and separating several battery cells, a cell carrier composite system as well as a battery carrier and a battery housing for a high-voltage battery.

It is already known from prior art that in battery-powered electric vehicles, the battery cells of a high-voltage battery required for propulsion are usually accommodated in the area below the driver's cab. The structural design is usually chosen to be flat in order to keep the vehicle height as low as possible and the vehicle's center of gravity as low as possible. Due to the fact that the batteries to be received have a low mechanical load capacity, the aforementioned position outside the front and rear crash zone of the vehicle is the best possible position. However, this position on the underbody of the vehicle, combined with the low mechanical load capacity of the battery cells, in turn results in requirements for the safety of a battery carrier and a battery housing to receive and enclose the battery cells.

Due to the high density of the materials used in batteries, such as nickel, copper, etc., battery cells are generally very heavy, which in turn poses a challenge for the load capacity and dynamic loads on the necessary battery carriers and battery housings.

In order to increase the energy density of the battery cells at cell compound level, the cells are packed as tightly as possible without additional enclosures of individual battery cells that reduce the packing density. In prior art, this installation is often referred to as “Cell to Pack” (C2P). Compared to previous structures, in which the individual battery cells were initially combined in individual modules, which was referred to as “Cell to Module” (C2M), the use of the C2P structure can eventually significantly improve the vehicle range with the same installation space compared to the C2M structure.

The C2P structure generally requires a very rigid battery carrier and a very rigid battery housing, respectively, to be formed as the structural rigidity is not necessarily given by the cell compound or the individual battery cells.

For smaller cells, the individual parts forming the battery housing in particular must be sufficiently rigid and strong. Moreover, the cells require a battery cell carrier to receive the cells in the correct position, spaced apart and electrically insulated.

In prior art cell carriers, the cell carrier is particularly configured to receive round cells such that the individual cells are inserted axially into the openings in the cell carrier provided for this purpose. Very precise guidance of the battery cells is required during the assembly process. In the case of radially cooled cells, the cooling lines must also be threaded into this cell carrier between the battery cells. The cell carrier structures from prior art have so far been very complex to assemble. Furthermore, in prior art, the previous configurations of the cell carriers are primarily used for positioning the cells. The structural-mechanical properties, such as a load-bearing function, are fulfilled by the actual battery housing, wherein the battery cells are usually potted or bonded.

The problem with prismatic cells is that the cells deform or swell during the charging process, so that the resulting bulge on the cell carriers from prior art is disadvantageous, as the deformation causes the battery cells to shift relative to the cell carrier and/or the battery housing.

Due to the potting or bonding of the battery cells to the cell carrier, subsequent recycling will also be very difficult or even impossible. Furthermore, as described above, the assembly effort for mounting the cell carriers is very high in order to achieve the required rigidity and strength, respectively. In particular in the previous cell carrier structures, the battery housings or battery carriers are also required to ensure suitable crash safety for the battery cells.

Based on the aforementioned prior art, the object of the present invention is to provide an improved cell carrier and an improved cell carrier composite system which significantly reduces the assembly effort, simplifies subsequent recycling and furthermore increases the rigidity and crash safety of the cell arrangement without requiring the battery cells to be bonded or potted.

According to the invention, the aforementioned object is achieved by a cell carrier strut for receiving and separating several battery cells, a cell carrier composite system comprising several cell carrier struts, a battery carrier and a battery housing.

According to a first aspect, the present invention relates to a cell carrier strut for receiving and separating several battery cells comprising a carrier body extending along an extension direction from a first end to an opposite second end and a stacking direction orthogonal to the extension direction. The carrier body comprises a separating web for forming a separating section in the stacking direction, the separating web having a first and a second side surface opposite one another in the stacking direction. The first and/or the second side surface comprise, along the extension direction, several elevations adapted to the battery cells to be received for positioning and receiving the battery cells.

According to the invention, the term adaptation of the elevations is to be understood as such that the elevations are adapted to the shape and size of the battery cells to be received, so that at least a part of the first and/or second side surface comprising the correspondingly adapted elevations provides a contact surface or abutment surface for the battery cells to be received.

Due to the provided formation of elevations in the area of the first and/or the second side surface, corresponding indentations can of course as a consequence also be formed in the area of the first and/or the second side surface in accordance with the invention. In other words, the first and/or the second side surface can comprise both several elevations adapted to the battery cells to be received and/or also several indentations adapted to the battery cells to be received.

The separating web forms a cross-sectional plane orthogonal to the extension direction and forms an “I”-shaped cross-sectional profile of the carrier body, wherein the cross-sectional profile has a width dimension in the stacking direction and a height dimension orthogonal to the extension direction and orthogonal to the stacking direction, and wherein the height dimension is many times greater than the width dimension. The width dimension can vary along the extension direction due to the formation of the several indentations and/or elevations adapted to the battery cells to be received.

The several battery cells can be arranged at a distance from one another along the extension direction, at least in partial areas along the first and/or second side surface of the cell carrier strut. Here, the battery cells get into contact in partial areas with the respective side surfaces of the cell carrier, wherein elevations and/or indentations being formed on the side surface for at least partial receiving and spacing of the battery cells in the carrier body of the cell carrier strut.

According to the invention, it may be provided that the several battery cells arranged along a cell carrier strut are separated from one another by the elevations and indentations, respectively, of the cell carrier and are also sealed off from one another, respectively, so that the battery cells cannot come into contact with one another. The carrier body has elevations and/or indentations on the first and/or second side surface in order to receive the cells in a precise position, furthermore for electrical insulation of the individual cells and in order to advantageously transfer forces acting on the cells to the structure and to minimize or completely avoid force or load transfer to the actual battery cells.

In a further optional embodiment of the cell carrier strut, the different geometric configuration of the elevations and/or indentations allows the mixed installation or the alternating reception and arrangement of prismatic and cylindrical battery cells to receive the cells in the area of the carrier body of a cell carrier strut. The mixed installation can be achieved both within a row of stacks, i.e. along the extension direction of a cell carrier strut, and preferably in the stacking direction, but by means of geometric variations.

The stacking direction or a stacking direction is orthogonal to the extension direction of the cell carrier strut, along which stacking direction several cell carrier struts with battery cells received therebetween can be stacked or packed and joined together to form a cell carrier composite system. Here, the individual battery cells are received between a first side surface of a first cell carrier strut and a second side surface of a second cell carrier strut proportionally to form a cell carrier composite system. By providing the indentations and/or elevations on the two first and second side surfaces, any number of cell carrier struts with individual battery cells can be joined together in a modular fashion. The cell carrier strut according to the invention thus provides a modular system, wherein several cell carrier struts and individual battery cells can be joined together to form a compact cell carrier composite system.

According to the invention, it may be provided that the elevations in the areas of the first and/or the second side surface are formed to receive prismatic and/or cylindrical battery cells.

The carrier body can also comprise an upper transverse flange, which adjoins an upper end surface of the separating web to form an L-shaped or T-shaped cross-sectional profile of the carrier body and to form an upper contact surface for the battery cells to be received, which adjoins the respective first and/or second side surface.

Furthermore, it may be provided that the carrier body additionally comprises a lower transverse flange, which adjoins a lower end surface of the separating web to form a C-, Z- or double-T-shaped cross-sectional profile of the carrier body and to form a lower contact surface for the battery cells to be received, which is adjacent to the respective first and/or second side surface.

The lower and/or upper contact surface is substantially orthogonal to the respective first and second side surface, respectively. The lower and/or upper transverse flange can respectively adjoin or be attached centrally to the respective end surface of the separating web, so that the lower and/or upper web protrudes on both sides of the separating web in the area of the first and the second side surface and also forms an upper and/or lower contact surface to the two side surfaces. However, according to the invention, it may alternatively also be provided to attach the lower and/or upper transverse flange eccentrically to the respective end surface of the separating web or to connect it thereto, so that the lower and/or upper web also protrudes only on one side of the separating web in the area of the first or the second side surface and forms a lower and/or upper contact surface only to one of the two side surfaces. According to the invention, a T-profile or a double-T-profile can thus be formed in cross-section in case of a central arrangement of the lower or upper transverse flange, and exemplary L-, C- or Z-shaped profiles can be formed in case of an eccentric arrangement.

According to the invention, it may also be provided that the elements forming the carrier body and thus in particular the separating web and the at least one upper and/or lower transverse flange are manufactured proportionally and integrally, for example as a singular injection-molded part.

Furthermore, it may be provided that several spaced recesses or holes are formed in the upper and/or lower transverse flange along the extension direction for the passage of electrical contacts and/or of safety valves of the battery cells to be received, for example.

The carrier body can comprise a hybrid material structure comprising at least a first component formed from a plastic and a second component formed from a stiffening material to increase the mechanical properties.

The materials for increasing the mechanical properties can be introduced locally in the area of highest loads, so that these bear the main loads. However, according to the invention, the carrier body can also be formed from a single singular type of material.

A plurality of reinforcing fibers extending along the extension direction can be embedded in the carrier body. It may be provided that the reinforcing fibers are preferably embedded unidirectionally along the extension direction, for example as unidirectional or as several unidirectional fiber layers in the carrier body or are connected thereto in a load-bearing manner. However, according to the invention, it may also be provided that a fabric or laid scrim formed from reinforcing fibers is embedded in the carrier body or connected thereto in a load-bearing manner.

The reinforcing fibers can preferably be embedded in the upper and/or lower transverse flange and/or in the separating web.

The reinforcing fibers can be carbon fibers, glass fibers or metal wire, for example.

In a preferred embodiment, the carrier body can be formed proportionally from a thermoplastic short or long glass fiber-reinforced plastic and proportionally from a continuous fiber-reinforced thermoplastic.

Furthermore, it may be provided that the carrier body comprises at least one end element at the first and/or second end in the direction of the extension direction to form an end contact surface for the battery cells to be received, which end contact surface is adjacent to the respective first and/or second side surface.

In the area of the first and/or second end, the carrier body can comprise a fastening device for fastening the cell carrier strut or the carrier body to a battery carrier or to a battery housing.

Compressible padded elements can preferably be arranged in the area of the first and/or the second side surface. The compressible padded elements are also commonly referred to as compression pads or swelling pads, for example, wherein the compressible padded elements can preferably be made of foam or of an aerogel. The compressible padded elements can be arranged in the area of the first and/or the second side surface, in particular in the area of the elevations or indentations. The compressible padded elements can either be pre-fixed to the first and/or the second surface or installed or arranged in the cell carrier body together with the assembly of the prismatic cells.

At least one recess can be formed in the separating web to receive a preferably active temperature control element in the area of the carrier body. Furthermore, according to the inventio, it may be provided that at least one cooling element, such as a cooling channel, can be embedded or introduced directly during the manufacture of the cell carrier strut, for example using an injection molding process. The cooling element, in particular a cooling channel, can be overmolded with plastic and thus firmly and positively connected to the carrier body of the cell carrier strut. Integration in the injection molding process eliminates the process step in assembly. Similarly, if the cooling element is made of a metal profile, such as an aluminum profile, it would become part of the structure reinforcing the cell carrier strut. It may be provided to introduce the cooling elements in each of the carrier bodies of the cell carrier struts and thus provide cooling in the stacking direction at the front and rear side of each battery cell to be received.

Furthermore, according to the invention, it may be provided to form the cell carrier strut or the carrier body in multiple layers, at least from two parts, wherein the individual parts preferably consist of the same material and are connected or joined together, for example by a welding or other joining process.

By joining the individual parts, a cavity can be formed in the cell carrier strut or the carrier body. In general, the carrier body can comprise a cavity, which is introduced in the area between the first and the second side surface of the cell carrier body and forms a cavity in which, for example, cooling or temperature control medium can be transported. The walls defining the cavity are in turn at least partially adjacent to the battery cells to be received, so that the battery cells only have a small distance to the temperature control medium and can therefore be actively temperature-controlled in a particularly effective manner. The above-described embodiment has the advantage that the carrier body itself or the actual material of the carrier body is used directly for cooling and at the same time also forms a load-bearing structure for receiving the battery cells. A particular advantage of the aforementioned embodiment is the purity of the material used, so that the cell carrier strut according to the invention or the corresponding carrier body, which also comprises a temperature control device, can nevertheless be easily recycled.

According to the invention, it may be provided that the carrier body is configured for stacking or lining up several cell carrier struts along the stacking direction.

The carrier body can preferably comprise first and second latching or locking elements adapted to one another in the area of the lower and/or upper transverse flange for the load-bearing connection of the carrier body to at least one further cell carrier strut or at least one further carrier body of a further cell carrier strut.

The latching elements can be arranged such that the latching is performed in the assembly direction of the cells or the struts.

It may also be provided that the latching elements are arranged such that cylindrical battery cells can be installed in a meander-shaped manner with the same component by rotating a strut by 180°.

A carrier body comprising at least one upper transverse flange and/or one lower transverse flange can also comprise a one-piece continuous or multi-piece projection divided into sections on the side surface of at least one transverse flange facing away from the separating web for spacing the carrier body from a contact surface of a battery carrier or a battery housing.

According to the invention, it may be provided that the separating web is box-shaped in the cross-sectional plane to form an intermediate space between the first and the second side surface.

Furthermore, according to the invention, it may be provided to arrange a structural profile in the intermediate space, which structural profile is connected to the carrier body of the cell carrier strut in a load-bearing manner or is at least partially embedded and enclosed in the material of the carrier body.

At least one attachment point for the load-bearing connection of the carrier body to a battery carrier or a battery housing can be formed in the intermediate space. The attachment points can comprise threaded inserts for fastening screws that are screwed into the threaded inserts from the outside of the housing through the cover or bottom. The attachment points can include at least one molded bore in the carrier body so that a self-tapping screw can be used to fasten the carrier body to a battery carrier or to a battery carrier housing.

The attachment points can also comprise circumferential sealings for encapsulating the battery carrier or the battery housing when using a screw connection from the outside of the housing or the battery carrier.

According to a second aspect, the present invention relates to a cell carrier composite system comprising a plurality of cell carriers according to the first aspect of the invention for receiving and separating several battery cells and preferably at least one tensions strap.

For the configuration of the cell carrier system, the cell carriers can receive a plurality of individual battery cells and be connected to one another in the stacking direction, so that a plurality of individual battery cells are always received between a first and a second cell carrier strut. By providing a plurality of cell carrier struts arranged next to one another in the stacking direction and connected to one another, a cell carrier composite system is formed, wherein preferably the plurality of cell carrier struts are connected to one another in the stacking direction by means of at least one tension strap or are subjected to a tensile force in the stacking direction by the tension strap.

The at least one tension strap can be formed from a tension-resistant material and preferably comprise at least one layer of a unidirectional fiber tape, with the longitudinal direction of the fibers being aligned in the longitudinal direction of the tension strap.

According to a third aspect, the present invention relates to a battery carrier comprising a plurality of cell carrier struts according to the first aspect of the invention or at least one cell carrier composite system according to the second aspect of the present invention as well as a battery carrier frame and a battery carrier lower part. The battery carrier lower part is adapted to be connected to the battery carrier frame to form a receiving space open on one side for arranging the cell carrier composite system or the plurality of stacked cell carrier struts.

According to a fourth aspect, the present invention relates to a battery carrier housing comprising at least one battery carrier and also a battery housing upper part, wherein the battery carrier lower part and the battery housing upper part are adapted to be connected to batty carrier frame to form a receiving space enclosed on all sides for arranging the cell carrier composite system or the plurality of stacked cell carrier struts.

In the following, exemplary embodiments of the cell carrier strut, of an exemplary cell carrier composite system, a battery carrier and a battery housing are illustrated with reference to the accompanying Figures.

### BRIEF DESCRIPTION OF THE DRAWINGS

FIGS. 1A and 1B are a perspective view of a first exemplary embodiment of a cell carrier strut according to the invention;

FIGS. 2A to 2C are views of a second exemplary embodiment of a cell carrier strut according to the invention;

FIGS. 3A to 3D are views of different exemplary embodiments of cell carrier struts according to the invention comprising temperature control means;

FIGS. 4A and 4B show a further exemplary embodiment of a cell carrier strut according to the invention having a box-shaped cross-section;

FIG. 5 shows an exemplary embodiment of a cell carrier composite system;

FIG. 6A shows an exemplary embodiment of a battery carrier according to the invention;

FIG. 6B shows an exemplary embodiment of a battery housing according to the invention;

FIG. 6C shows a further exemplary embodiment of a battery carrier frame;

FIGS. 7A to 7C show an exemplary embodiment of a battery housing according to the invention with a received cell carrier composite system according to the invention;

FIG. 8 shows a further exemplary embodiment of a battery housing according to the invention comprising a cell carrier composite system according to the invention.

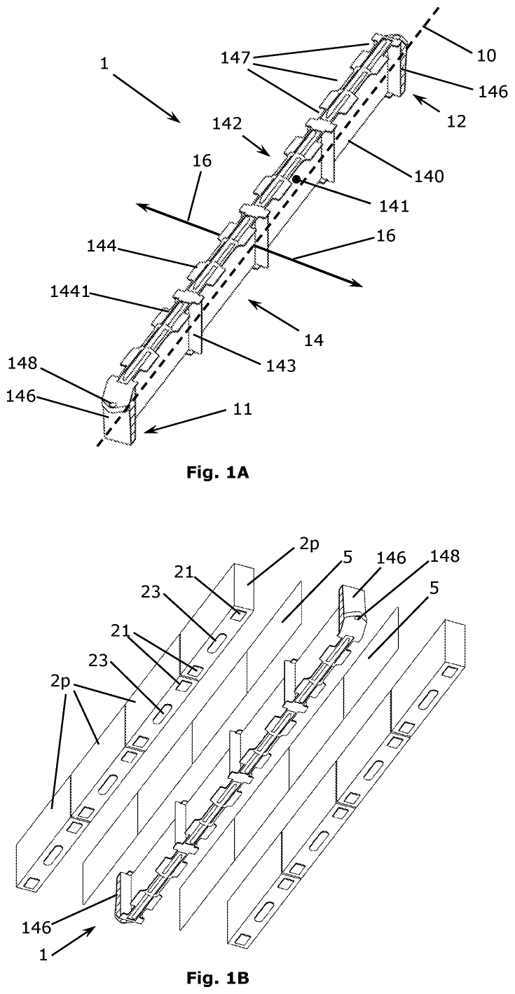

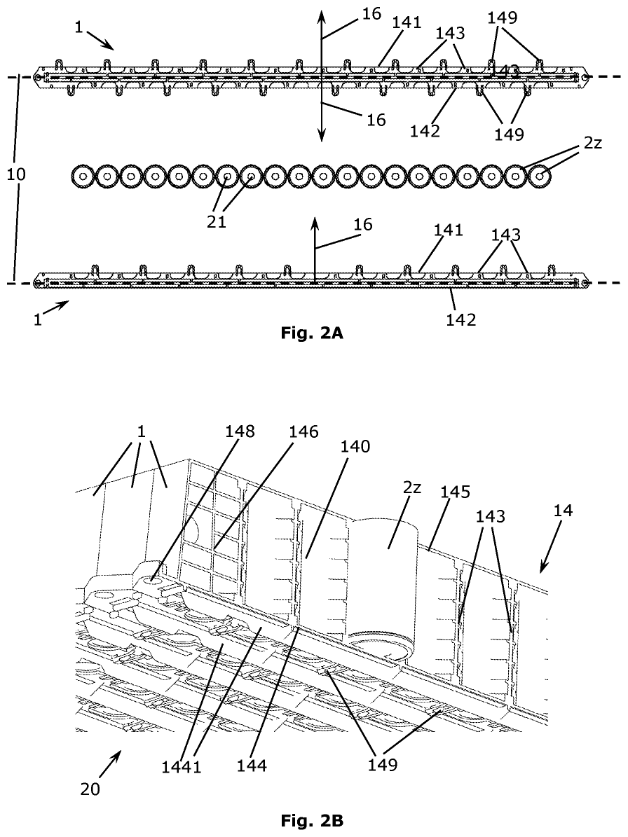

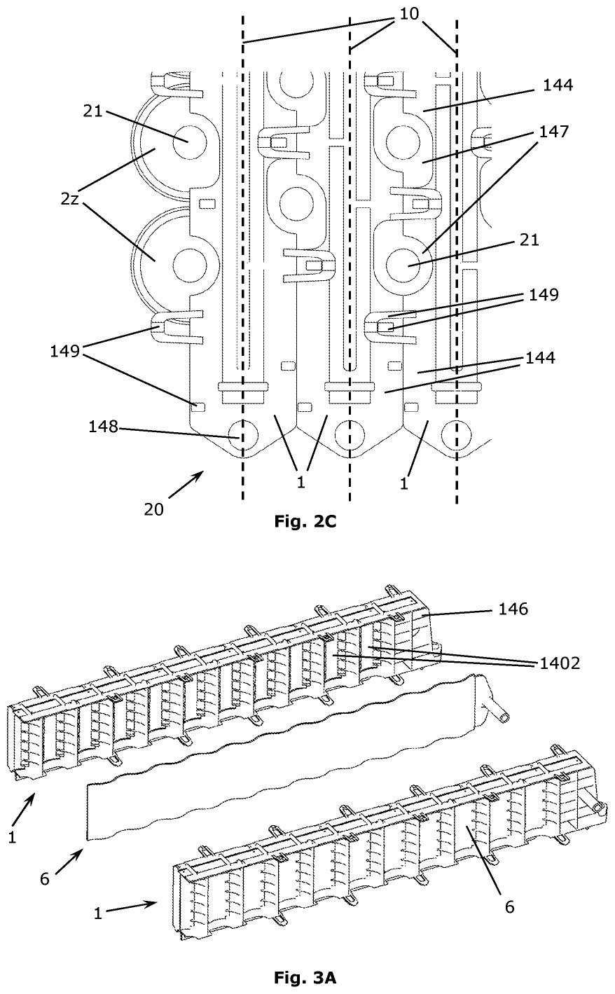

FIGS. 1A and 1B show a first exemplary embodiment of a cell carrier strut 1 according to the invention which, in the embodiment according to FIG. 1, is configured to receive several, namely on both sides four, prismatic battery cells 2p. In FIGS. 1, the reception of prismatic battery cells 2p is selected only as a possible example; of course, the cell support strut 1 could also be configured to receive cylindrical battery cells 2z, as shown in FIG. 2. According to the invention, cell carrier strut 1 is configured to receive and separate several battery cells 2 of any form (e.g. prismatic battery cells 2p and/or cylindrical battery cells 2z) comprising a carrier body 14 extending along an extension direction 10 from a first end 11 to an opposite second end 12 and a stacking direction orthogonal to extension direction 10. The carrier body 14 in turn comprises a separating web 140 for forming a separating section in stacking direction 16 having a first and a second side surface 141, 142 opposite one another. In the exemplary embodiment according to FIGS. 1A and 1B, the first and the second side surface 141, 142 each comprise, along extension direction 10, a plurality of elevations 143 adapted to the battery cells 2 to be received or, more precisely in the embodiment according to FIGS. 1, to the prismatic battery cells 2z to be received, for receiving the battery cells 2z. In the illustrated embodiment according to FIGS. 1, the elevations 143 are rib-shaped. Due to the respective formation of the two opposite side surfaces 141, 14 with the aforementioned elevations 143, several battery cells 2p can be received on both sides of the aforementioned cell carrier strut 1 according to the invention, as shown in FIG. 1B. In the illustrated embodiment according to FIGS. 1, the cell carrier strut comprises four spaced receiving areas for the prismatic battery cells 2p on the two side surfaces 141, 142 along extension direction 10.

As can also be seen in FIGS. 1, the configuration of the elevations 143 forms areas that are retracted relative to the elevations in the area of the first or the second side surface 141, 142, in which the battery cells 2p can be arranged and at least partially received. The elevations 143 are formed in conjunction with separating web 140 in such a way that a secure and spaced arrangement and reception of the battery cells 2p is ensured by cell carrier strut 1 according to the invention. In the illustrated embodiment, the elevations 143 in the area of the first and the second side surface 141, 142 are configured to receive prismatic battery cells.

The exemplary embodiment of cell carrier strut 1 according to the invention shown in FIG. 1A further comprises an upper transverse flange 144, which directly adjoins an upper end surface of separating web 140 and, in the embodiment shown according to FIGS. 1, forms a T-shaped cross-section of carrier body 14, wherein at the same time an upper contact surface adjacent to the first and the second side surface 141, 142 is formed for the battery cells 2 to be received or, according to FIGS. 1, for the prismatic battery cells 2p.

Furthermore, it can be seen in FIG. 1 that, in the area of the upper transverse flange 144 along extension direction 10, several recesses 147 spaced apart from one another are formed for the passage of electrical contacts 21 and of safety valves 23 of the prismatic battery cells 2z to be received. FIG. 1B exemplarily shows eight prismatic battery cells 2p, each comprising two electrical contacts 21 and a safety valve 23 in the central area. The safety valve 23 of battery cell 2z is used to discharge gases and particles resulting from a thermal runaway or a cell fire in a controlled manner.

Furthermore, it can be seen from the exemplary embodiment of cell carrier strut 1 according to FIG. 1 that it comprises an end element 146 in the area of the first and the second end 11, 12 in the direction of extension direction 10, again to form a contact surface adjacent to the respective first and second side surface 141, 142 for the battery cells 2p to be received. With regard to end element 146, it can be seen from FIG. 1 that it is designed with a large material thickness in extension direction 10, such that this provides increased rigidity and also protection for the battery cells 2 to be received.

The cell carrier strut 1 according to FIG. 1 also comprises respectively one fastening device 148 in the area of carrier body 14 in the area of the first and/or the send end 11, 12 for fastening cell carrier strut 1 to a battery carrier which is not illustrated or to a battery housing. In the illustrated embodiment according to FIGS. 1, fastening device 148 is configured as a fastening tab protruding from carrier body 14 with a central receiving point for the passage of a fastening means, such as a screw.

As can be seen in FIG. 1B, it may be provided that compressible padded elements 5 are arranged in the area of the first or the second side surface 141, 142. The compressible padded elements 5 are used to compensate for possible deformations of the battery cells 2p to be received. For example, it is known from prior art that increasing electrical charging of the prismatic battery cell 2p leads to central bulging, which can be advantageously compensated for by the padded elements 5. A further advantage of the aforementioned embodiment of the provision of the padded elements 5 is that they mechanically decouple the battery cells 2 to be received from the actual structure of the cell carrier struts 1, wherein any loads occurring are absorbed by the cell carrier struts 1 and in particular the cell carrier bodies 14 and are not transferred directly to the battery cells 2p. In the embodiments according to FIGS. 1, the upper transverse flange 144 comprises a multi-piece projection 1441 on the surface facing away from separating web 114, for spacing carrier body 140 from a contact surface of a battery carrier or a battery housing.

FIGS. 2A to 2C show a second exemplary embodiment of a cell carrier strut 1 according to the invention. In the embodiments according to FIGS. 2, cell carrier strut 1 comprises a plurality of elevations 143 configured to receive a plurality of cylindrical battery cells 2z.

Here, FIG. 2A already shows two different embodiments of a cell carrier strut 1 according to the invention, which is initially designed similarly to FIG. 1. In contrast to the embodiment according to FIG. 1, the elevations 143 are adapted to receive cylindrical battery cells 2z. According to the invention, it may be provided, as illustrated in FIG. 2A in the upper cell carrier strut, that the aforementioned elevations are formed in the area of the first side surface 141 and also of the second side surface 142 or, as illustrated in FIG. 2A in the lower cell support strut 1, the aforementioned elevations 143 are formed only in the area of the first side surface 141. Cylindrical battery cells 2z can therefore be received on both sides of carrier body 14 on cell carrier strut 1 shown at the top in FIG. 2A. In contrast, cell carrier strut 1 shown at the bottom in FIG. 2A can receive several cylindrical battery cells 2z along extension direction 10 only on one side in the area of the first side surface 141. The cell carrier strut 1 shown at the bottom can therefore be used, for example, as the end element of a cell carrier composite system.

FIG. 2A also shows the corresponding stacking directions of the cell carrier struts 1 with arrows 16. Accordingly, the lower cell carrier strut 1 can only be stacked on one side starting from the first side surface 141 and connected to further cell carrier struts 1. As shown by the double arrow 16 in the upper cell carrier strut 1 according to FIG. 2A, it can be connected or stacked on both sides starting from the first side surface 141, but also starting from the second side surface 142, with further cell carrier struts 1 to form a cell carrier composite system according to the invention.

FIG. 2B shows a detailed view of cell carrier strut 1 according to the invention according to FIG. 2A. As can be seen in FIG. 2B, carrier body 14 comprises a separating web 140 for forming a separation section in stacking direction 16 having a first side surface 141 and a corresponding opposite second side surface 142. FIG. 2B shows several elevations 143 adapted to the cylindrical battery cells 2z to be received. Unlike in the exemplary embodiments according to FIGS. 1, the elevations 143 in FIG. 2 are not merely formed as protruding webs, but have a three-dimensional geometry adapted to the cylindrical surface structures to form preferably half shells receiving the cylindrical cells 2z.

The carrier body 14 in the illustrated embodiment according to FIG. 2 has an upper transverse flange 144, which adjoins an upper end surface of separating web 140 and forms an upper contact surface for the battery cells 2z to be received, which is adjacent to the respective first and second side surface 141, 142. Furthermore, carrier body 14 in FIG. 2 comprises a lower transverse flange 145, which adjoins a lower end surface of separating web 140, wherein a double-T-shaped cross-sectional profile of carrier body 14 is formed accordingly in cross-section, the lower transverse flange 145 forms a corresponding lower contact surface for the battery cells 2z to be received in the area of the first and the second side surface 141, 142.

In the embodiment according to FIGS. 2, carrier body 14 comprises respectively one end element 146 in the area of the first and the second end 11, 12 in the direction of extension direction 10. Furthermore, cell carrier strut 1 comprises respectively one fastening device 148 in the area of carrier body 140 on the first and the second end 11, 12 for fastening cell carrier strut 1 to a battery carrier 3 which is not illustrated or to a battery housing 4.

In the exemplary embodiment according to FIGS. 2, carrier body 14 comprises a plurality of first and second latching elements 149 adapted to one another in the area of the upper transverse flange 144 for the load-bearing connection of carrier body 14 to at least one further cell carrier strut 1. As can be seen in particular from FIGS. 2B and 2C, a plurality of cell carrier struts 1 with battery cells 2 or 2z received therebetween can be connected to one another in a load-bearing manner by the first and the second latching element 149 adapted to one another, and a cell carrier composite system 20 can be formed. As can be seen in particular from FIG. 2B, the upper transverse flange 144 comprises a continuous projection 1441 on the surface facing away from separating web 140, which in the embodiment shown extends along extension direction of cell carrier strut 1 for spacing carrier body 14 from a contact surface of a battery carrier or a battery housing 4. It can also be seen in FIG. 2C that the upper transverse flange 144 comprises a plurality of recesses 147 for passing through or exposing the electrical contacts 21 of the battery cells 2z. As can also be seen in FIG. 2C, the recesses 147 are adapted to the shape of electrical contact 21 of the cylindrical battery cell 2z to be received such that only the immediate area of electrical contact 21 is exposed, but otherwise battery cell 2z is covered as comprehensively as possible by the upper flange 144 or enclosed or covered by cell carrier body 14.

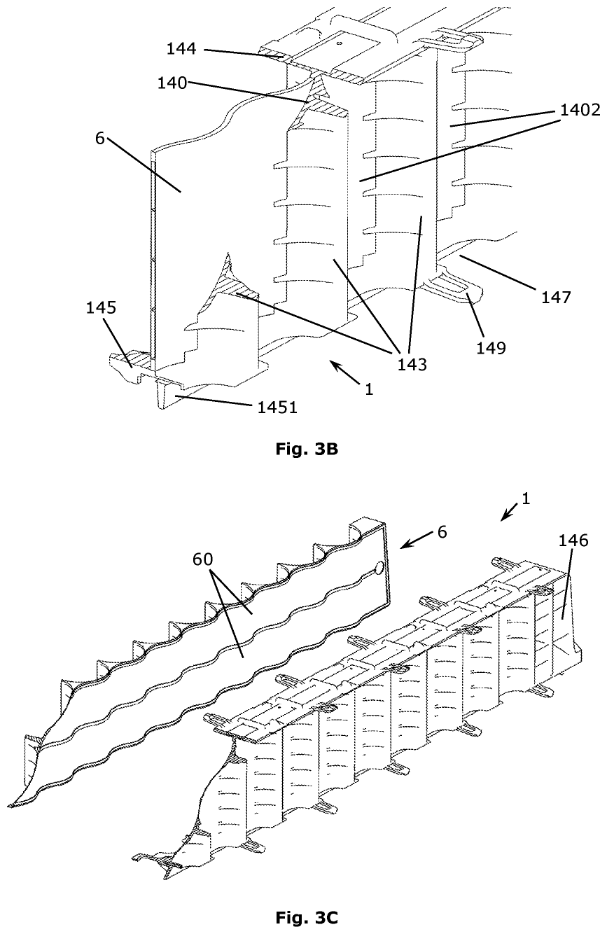

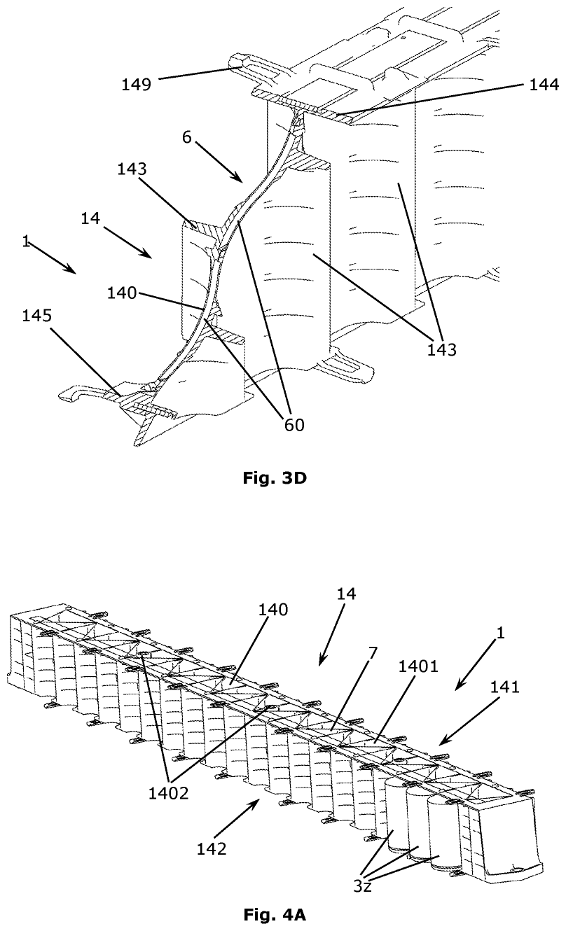

FIGS. 3A to 3D show further exemplary embodiments of cell carrier struts 1 according to the invention. In the illustrated exemplary embodiments of FIGS. 3, the cell carrier struts 1 are each configured to receive cylindrical battery cells 2z, but can alternatively be configured differently to receive prismatic battery cells 2p.

The cell carrier struts 1 according to FIG. 3 substantially comprise the previously described features of the cell carrier struts 1 according to the invention. However, the cell carrier struts 1 according to FIG. 3 are also configured to include or receive a temperature control element 6 in carrier body 14 for active temperature control of the battery cell. In FIG. 3, a plurality of recesses 1402 are formed in the area of separating web 140 to receive a preferably active temperature control element 6 in carrier body 14. In the upper two partial illustrations of FIG. 3A, temperature control element 6 is shown separately from cell carrier strut 1 to better illustrate recess 1402 provided in the area of the separating web. The end element 146 can also comprise a recess or more precisely a hole for the passage of a connection piece of temperature control element 6 for the supply of a temperature control medium, in particular.

In the lower partial illustration of FIG. 3A, temperature control element 6 is shown in the configuration received in carrier body 14. It can be seen in FIG. 3A that by providing recess 1402 in the area of separating web 140, temperature control element 6 is formed directly adjacent to the battery cells 2 or 2z to be received, which is preferable for conductive heat transport.

FIG. 3B shows a further exemplary embodiment of a cell carrier strut 1 comprising an active temperature control element 6, wherein the active temperature control element 6 is embedded in the area of carrier body 14. If carrier body 14 is configured as an injection-molded part, said temperature control element 6 can be directly partially overmolded or embedded in carrier body 14 during the injection molding process. As can also be seen in FIG. 3B, in this embodiment it is also provided that carrier body 14 comprises a plurality of recesses 1402 between the elevations 143, so that in this embodiment temperature control element 6 also comes into direct contact with the battery cells 2 or 2z to be received.

FIG. 3C, 3D shows a further exemplary embodiment of a cell carrier strut 1 comprising a temperature control element 6, which in the exemplary embodiment according to FIGS. 3C and 3D is formed directly as a recess in carrier body 14 and in particular in separating web 140. In the illustrated embodiment according to FIGS. 3C and 3D, respectively, separating web 140 comprises integrated channels 60 for the passage of a temperature control medium. In the illustrated embodiment according to FIGS. 3C and 3D, cooling element 6, which is integrated in cell body 14, has two channels 60 lying one above the other for the passage of a temperature control medium. Due to the channels 60 lying one above the other, the temperature control medium can preferably be passed in opposite directions to realize countercurrent temperature control.

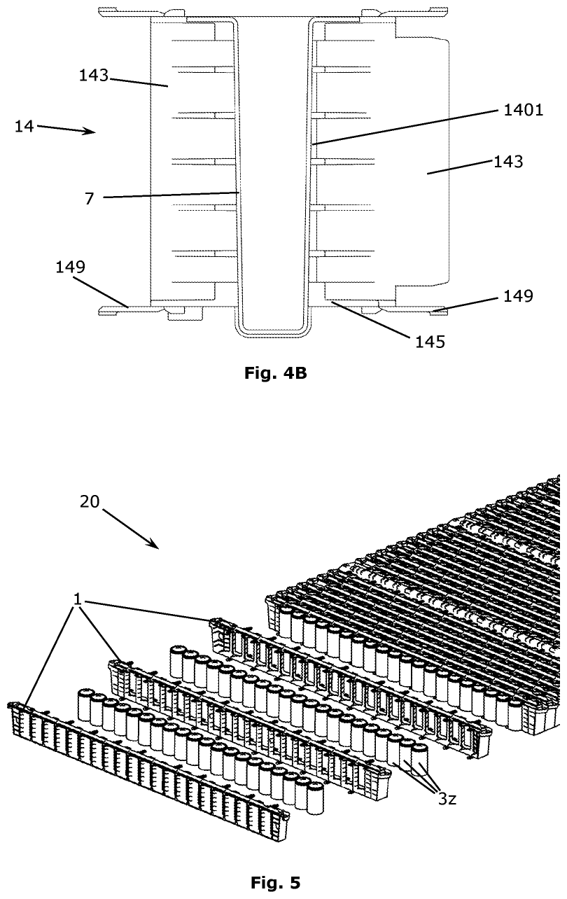

FIGS. 4A and 4B show a further exemplary embodiment of a cell carrier strut 1, which, as already explained above, can be provided with features. The cell support strut 1 according to FIGS. 4A and 4B has the special feature that separating web 140 is box-shaped in the cross-sectional plane to form an intermediate space 1401 between the first and the second side surface 141, 142. As can be seen in FIG. 4B in particular, but also in FIG. 4A, a structural profile 7 can be arranged in intermediate space 1401 and connected to the structure of carrier body 14 in a load-bearing manner. In particular, structural profile 7 can have a U-shaped cross-sectional area or a cross-sectional area formed by a closed hollow profile and formed to be elongated in extension direction 10. Preferably, ribs spaced apart in extension direction 10 can be provided to stiffen structural profile 7. In the embodiments according to FIG. 4, it may also be provided that at least one attachment point 1402 for the load-bearing connection of carrier body 14 to a battery carrier or a battery housing is formed in the aforementioned intermediate space 1401.

FIG. 5 shows an exemplary embodiment of a cell carrier composite system 20, wherein a plurality of cell carrier struts 1 are stacked with a plurality of cylindrical battery cells 3z to be received and cell carrier struts 1 are connected to one another, for example by means of latching elements 149, to form a cell carrier composite system 20. The cell carrier composite system 20 can also comprise at least one tensions strap, which is not illustrated in the Figures, made from a tension-resistant material and applying a pretension to the cell carrier composite system 20 in the stacking direction. The tension-resistant material can comprise at least one layer of a unidirectional fiber tape, with the longitudinal direction of the fibers being aligned in the longitudinal direction of the tension strap.

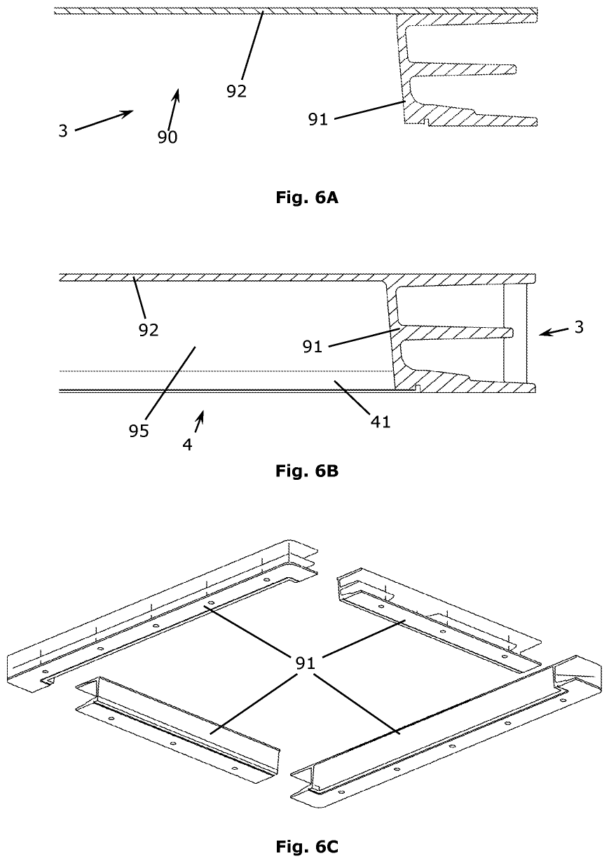

FIG. 6A shows a detailed section of a battery carrier 3 according to the invention comprising at least one battery carrier frame 91 and a battery carrier lower part 92. The battery carrier lower part 92 is adapted to be connected to the battery carrier frame 91 to form a receiving space 90 open on one side for arranging the cell carrier composite system 20 or the plurality of stacked cell carrier struts 1. For better clarity, the cell support composite system 20 and the cell support struts 1, respectively, are not shown in FIG. 6A.

FIG. 6B shows an exemplary embodiments of a battery housing 4 according to the invention comprising a battery carrier 3 and a battery housing upper part 41 for forming a receiving space 95 enclosed on all sides. As shown in FIG. 6B, the battery carrier lower part 92 and the battery carrier frame 91 are integrally formed in the embodiment shown in FIG. 6B.

FIG. 6C shows an exemplary embodiment of a battery carrier frame 91, which is composed of several individual parts that can be connected to each other.

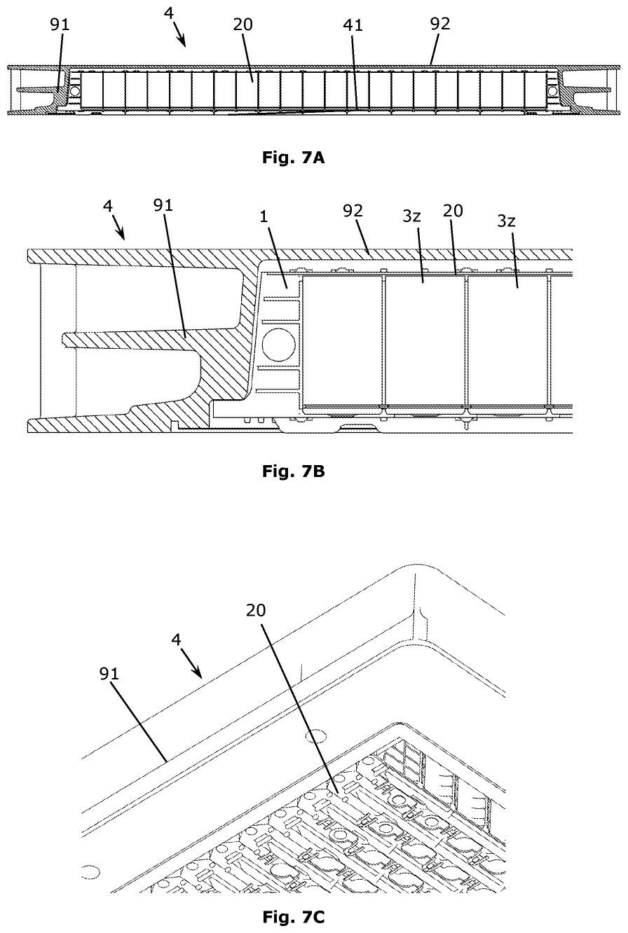

FIGS. 7A to 7C show a battery housing 4 according to the invention in which a cell carrier composite system 20 is received. For better illustration, the battery housing upper part 41 is not shown in the exemplary battery housing 4.

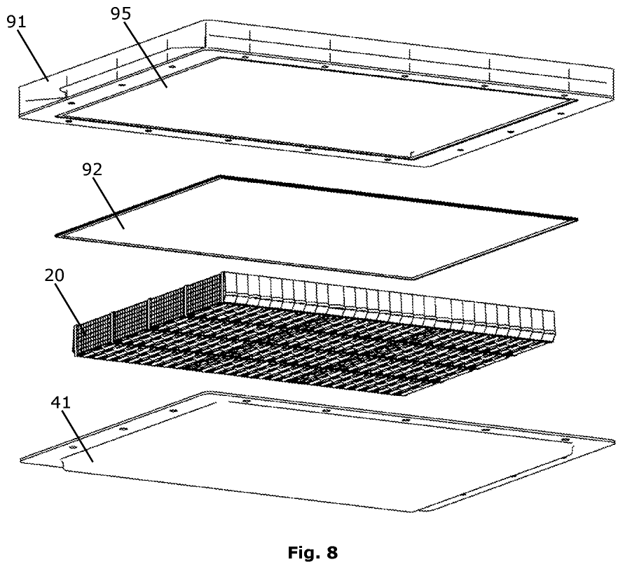

FIG. 8 shows a further exemplary embodiment of a battery housing 4 initially comprising a battery carrier frame 91, a battery carrier lower part 92 and a battery housing upper part 41 for forming a receiving space 95 enclosed on all sides for receiving and arranging the cell carrier composite system 20.

What is claimed is:

1. A cell carrier strut for receiving and separating several battery cells comprising a carrier body extending along an extension direction from a first end to a second end and a stacking direction orthogonal to the extension direction;
wherein the carrier body comprises a separating web for forming a separating section in the stacking direction having a first and a second side surface opposite one another; and
wherein the first and/or the second side surface comprises, along the extension direction, several elevations adapted to the battery cells to be received for receiving the battery cells.

2. The cell carrier strut according to claim 1, wherein the elevations are formed in the area of the first and/or the second side surface for receiving prismatic battery cells and/or cylindrical battery cells.

3. The cell carrier strut according to claim 1, wherein the carrier body further comprises an upper transverse flange, which adjoins an upper end surface of the separating web to form a “T”- or “T”-shaped cross-sectional profile of the carrier body and to form an upper contact surface for the battery cells to be received, which adjoins the respective first and/or second side surface.

4. The cell carrier strut according to claim 1, wherein the carrier body further comprises a lower transverse flange, which adjoins a lower end surface of the separating web to form a “C”-, “Z”- or “double-T”-shaped cross-sectional profile of the carrier body and to form a lower contact surface for the battery cells to be received, which is adjacent to the respective first and/or second side surface.

5. The cell carrier strut according to claim 3, wherein several spaced recesses or holes are formed in the upper and/or lower transverse flange along the extension direction for the passage of electrical contacts and/or of safety valves of the battery cells to be received.

6. The cell carrier strut according to claim 1, wherein the carrier body comprises a hybrid material structure comprising at least a first component formed from a plastic and a second component formed from a stiffening material to increase the mechanical properties.

7. The cell carrier strut according to claim 1, wherein a plurality of reinforcing fibers extending along the extension direction are embedded in the carrier body.

8. The cell carrier strut according to claim 1, wherein the carrier body comprises at least one end element at the first and/or second end in the direction of the extension direction to form an end contact surface for the battery cells to be received, which end contact surface is adjacent to the respective first and/or second side surface.

9. The cell carrier strut according to claim 1, wherein the carrier body comprises a fastening device in the area of the first and/or the second end for fastening the cell carrier strut to a battery carrier or a battery housing.

10. The cell carrier strut according to claim 1, wherein compressible padded elements are arranged in the area of the first and/or the second side surface.

11. The cell carrier strut according to claim 1, wherein at least one recess is formed in the separating web to receive a preferably active temperature control element in the carrier body for conductive temperature control of the battery cells.

12. The cell carrier strut according to claim 1, wherein the carrier body is configured for stacking or lining up several cell carrier struts along the stacking direction.

13. The cell carrier strut according to claim 1, wherein the carrier body, preferably in the area of the lower and/or the upper transverse flange, comprises first and second latching elements adapted to one another for the load-bearing connection of the carrier body to at least one further cell carrier strut.

14. The cell carrier strut according to claim 1,
wherein the carrier body comprises at least an upper transverse flange and/or a lower transverse flange,
wherein the upper transverse flange adjoins an upper end surface of the separating web to form a “T”- or “T”-shaped cross-sectional profile of the carrier body and to form an upper contact surface for the battery cells to be received, which adjoins the respective first and/or second side surface, wherein thadjoins a lower end surface of the separating web to form a “C”-, “Z”- or “double-T”-shaped cross-sectional profile of the carrier body and to form a lower contact surface for the battery cells to be received, which is adjacent to the respective first and/or second side surface,
wherein the lower transverse flange adjoins a lower end surface of the separating web to form a “C”-, “Z”- or “double-T”-shaped cross-sectional profile of the carrier body and to form a lower contact surface for the battery cells to be received, which is adjacent to the respective first and/or second side surface, and
wherein at least one transverse flange comprises a one-piece continuous or multi-piece projection divided into sections on the surface facing away from the separating web for spacing the carrier body from a contact surface of a battery carrier or a battery housing.

15. The cell carrier strut according to claim 1, wherein the separating web is box-shaped in the cross-sectional plane to form an intermediate space between the first and the second side surface.

16. The cell carrier strut according to claim 15, wherein a structural profile is arranged in the intermediate space and connected to the carrier body in a load-bearing manner.

17. The cell carrier strut according to claim 16, wherein the structural profile comprises a U-shaped cross-sectional area or a cross-sectional area formed by a closed hollow profile and is elongated in the extension direction and preferably comprises ribs spaced apart in the extension direction for stiffening the structural profile.

18. The cell carrier strut according to claim 15, wherein at least one attachment point for load-bearing connection of the carrier body to a battery carrier or a battery housing is arranged in the intermediate space.

19. A cell carrier composite system comprising:
a plurality of cell carrier struts according to claim 1 for receiving and separating several battery cells; and
at least one tension strap.

20. The cell carrier composite system according to claim 19, wherein the at least one tension strap is made from a tension-resistant material, preferably comprises at least one layer of a unidirectional fiber tape, with the longitudinal direction of the fibers being aligned in the longitudinal direction of the tension strap.

21. A battery carrier comprising:
a plurality of cell carrier struts according to claim 1,
a battery carrier frame, and
a battery carrier lower part;
wherein the battery carrier lower part can be connected to the battery carrier frame to form a receiving space open on one side for arranging the cell carrier composite system or the plurality of stacked cell carrier struts.

22. A battery housing comprising:
at least one battery carrier according to claim 21 and a battery housing upper part,
wherein the battery housing upper part and the battery carrier lower part can be connected to the battery carrier frame to form an enclosed receiving space for arranging the cell carrier composite system or the plurality of stacked cell carrier struts.
